(19) United States
(12) Patent Application Publication
(10) Pub. No.: US 2025/0083988 A1
(43) Pub. Date: Mar. 13, 2025

(54) POROUS GLASS ATOMIZATION CORE, PRODUCTION METHOD THEREFOR AND ELECTRONIC ATOMIZER

(71) Applicant: SHENZHEN SMOORE TECHNOLOGY LIMITED, Shenzhen (CN)

(72) Inventors: Congming YANG, Shenzhen (CN); Jicai LONG, Shenzhen (CN); Qianyuan ZHOU, Shenzhen (CN); Lei FU, Shenzhen (CN); Hongming ZHOU, Shenzhen (CN)

(21) Appl. No.: 18/953,987

(22) Filed: Nov. 20, 2024

Related U.S. Application Data
(63) Continuation of application No. PCT/CN2023/095363, filed on May 19, 2023.

(30) Foreign Application Priority Data
May 25, 2022 (CN) 202210579323.5

(51) Int. Cl. C03B 11/12; A24F 40/46; A24F 40/70; C03B 19/02; C03B 19/06; C03C 14/00

(52) U.S. Cl. CPC C03B 11/122; A24F 40/70; C03B 19/025; C03B 19/06; C03C 14/002; A24F 40/46; C03C 2214/30; C03C 2218/112; C03C 2218/115; C03C 2218/119

(57) ABSTRACT

A production method for a porous glass atomization core includes: S1: producing porous glass by: scheme one: a production method for the porous glass including: mixing glass powder, a fiber component, a pore-forming agent, and an additive phase to produce a green body, and performing debinding and sintering to obtain the porous glass; or scheme two: a production method for the porous glass including: mixing glass powder, a fiber component, and a pore-forming agent to produce a green body, and performing debinding and sintering to obtain the porous glass; and S2: using the porous glass as a substrate, and arranging a heating unit on the substrate.

### CROSS-REFERENCE TO PRIOR APPLICATION

This application is a continuation of International Patent Application No. PCT/CN2023/095363, filed on May 19, 2023, which claims priority to Chinese Patent Application No. 202210579323.5, filed on May 25, 2022. The entire disclosure of both applications is hereby incorporated by reference herein.

### FIELD

This application relates to the technical field of electronic atomization devices, and in particular to a porous glass atomization core, a production method therefor, and an electronic atomizer.

### BACKGROUND

An electronic atomizer is a product that converts an atomizing medium and the like into vapor by atomization and other means, so that users inhale the vapor. An atomization core is a core component of the electronic atomizer, and plays a vital role in the taste, aerosol volume and other performance of the electronic atomizer.

Most of closed electronic atomizers use porous ceramics as atomization cores. Most of porous ceramics are produced by accumulation of particles prepared by using diatomaceous earth, silicon oxide, alumina, and the like as raw materials, and adding glass powder, pore-forming agents, and the like through sintering. Porous ceramics are used as atomization cores, which has the characteristics of good uniformity, long service life, delicate taste and high degree of mechanization. However, porous ceramic heating elements have a certain proportion of semi-closed pores and micropores, which can easily cause the adsorption of low-viscosity components in the atomizing mediums, thereby affecting the smoking taste and aroma reduction degree. At the same time, the porous ceramic heating element has a rough microscopic surface and relatively low continuity, and cannot be used with a thin-film heating film.

Compared with porous ceramics, porous glass has the characteristics of smooth and continuous microstructure, and relatively low proportion of micro-nanopores, and is not easy to adsorb the atomizing mediums. At present, the porous glass is generally produced by using a pore-forming agent method, a foaming method or a sponge impregnation method. According to the foaming method, it is difficult to accurately control the size of porous glass produced by glass softening, foaming and annealing, and the closed-pore rate is relatively high. According to the sponge impregnation method, the porous glass is produced by using sponge as a framework, debinding and sintering, however, the porous glass has the problems of too large pore size (greater than 300 μm), uneven pore distribution and easy collapse during sintering, and is unsuitable as the atomization core. The pore structure of samples produced directly by the pore-forming agent method is prone to collapse after glass reaches the softening point, and the requirements of both microstructural continuity and high porosity cannot be ensured at the same time.

Therefore, an atomization core with porous glass as a substrate needs to be developed.

### SUMMARY

In an embodiment, the present invention provides a production method for a porous glass atomization core, comprising: S1: producing porous glass by: scheme one: a production method for the porous glass comprising: mixing glass powder, a fiber component, a pore-forming agent, and an additive phase to produce a green body, and performing debinding and sintering to obtain the porous glass; or scheme two: a production method for the porous glass comprising: mixing glass powder, a fiber component, and a pore-forming agent to produce a green body, and performing debinding and sintering to obtain the porous glass; and S2: using the porous glass as a substrate, and arranging a heating unit on the substrate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagram showing the surface (left) and cross-section (right) of porous glass produced in Example 1 of this application;

FIG. 2 shows morphologies of the surface (left) and cross-section (right) of porous glass produced in Example 2 of this application;

FIG. 3 shows morphologies of the surface (left) and cross-section (right) of porous glass produced in Example 3 of this application;

FIG. 4 shows morphologies of the surface (left) and cross-section (right) of porous glass produced in Example 4 of this application;

FIG. 5 shows morphologies of the surface (left) and cross-section (right) of porous glass produced in Example 5 of this application;

FIG. 6 shows morphologies of the surface (left) and cross-section (right) of porous glass produced in Example 6 of this application;

FIG. 7 shows morphologies of the surface (left) and cross-section (right) of porous glass produced in Comparative Example 1 of this application;

FIG. 8 shows a schematic structural diagram of an atomization core provided by this application;

FIG. 9 shows morphologies of the surface (left) and cross-section (right) of porous glass produced in Example 7 of this application;

FIG. 10 shows a micro-morphology of the surface of porous glass produced in Example 8 of this application;

FIG. 11 shows a micro-morphology of the surface of porous glass produced in Example 9 of this application;

FIG. 12 shows a micro-morphology of the surface of porous glass produced in Example 10 of this application;

FIG. 13 shows a micro-morphology of the surface of porous glass produced in Comparative Example 2 of this application;

FIG. 14 shows a comparison curve of smoke volume during a smoking process between Example 7 of this application and a commercially available ceramic heating element;

FIG. 15 shows a comparison diagram of carbon deposition between Example 7 of this application and a commercially available ceramic heating element; and

FIG. 16 shows an appearance morphology (left) and a micro-morphology (right) of the atomization core provided by this application.

### DETAILED DESCRIPTION

In an embodiment, the present invention overcomes the defects of porous glass atomization cores in the prior art, such as low porosity and easy collapse of the pore structure, thereby providing a porous glass atomization core and a production method therefor and an electronic atomizer.

This application provides a production method for a porous glass atomization core, including the following steps:
S1, producing porous glass by adopting the following schemes:
scheme one: a production method for the porous glass including: mixing glass powder, a fiber component, a pore-forming agent and an additive phase to produce a green body, and performing debinding and sintering to obtain the porous glass;
or scheme two: a production method for the porous glass including: mixing glass powder, a fiber component, and a pore-forming agent to produce a green body, and performing debinding and sintering to obtain the porous glass;
S2, using the porous glass as a substrate, and arranging a heating unit on the substrate. Optionally, the fiber component has a diameter of 3-30 μm and a length of 20-500 μm; optionally, the fiber component has a diameter of 10-25 μm and a length of 20-150 μm.

Optionally, the aspect ratio of the fiber component is 1-10; optionally, the aspect ratio of fibers with a length of 50-150 μm is 2-5;
and/or, the proportion of fibers with a fiber length of 50 μm or more in the fiber component is 25%; optionally, the proportion is 40% or more; further optionally, the proportion is 40-100%.

Optionally, in scheme one, raw materials include 15-50% of fiber component by the total mass of the raw materials; optionally, by the total mass of the raw materials, the raw materials include the following mass percent of components:
20-70% of glass powder; 15-50% of fiber component; 10-70% of pore-forming agent; 0-50% of additive phase. Further optionally, the mass percent of the additive phase is 1-50%;
or, in scheme two,
by the total mass of the glass powder and the fiber component, the proportion of the glass powder is 40-62%, and the proportion of the fiber component is 38-60%;
and/or, the amount of the pore-forming agent used is 0.3-2.5 times the total mass of the glass powder and the fiber component.

Optionally, in scheme one and scheme two, any one of a casting process, an injection molding process, a dry pressing process and a gel casting process is independently selected to produce the green body;
the above processes for producing green bodies are all known in the art, and corresponding processing aids may be added and used according to different selected processes. Typically, but not limiting, the injection molding process substantially includes the following steps: performing airtight mixing on mixed materials and injection molding additives (paraffin, polyethylene, a dispersant, and the like) in an internal mixer at a high temperature until the mixed materials and the additives are uniform, and then producing a green body of a specified shape by injection molding of the materials.

And/or, the debinding temperature is 200-800° C., and the debinding time is 5-50 h. Optionally, the debinding temperature is 200-350° C. Generally, a better debinding process can be obtained based on a thermogravimetric curve of the pore-forming agent.

And/or, the sintering temperature is 900-1250° C. or 1180-1320° C., and the sintering time is 10-180 min.

Optionally, the production method for the porous glass meets at least one of the following (1) to (5):
(1) the softening temperature of the glass powder is 600-1200° C.; if the softening point of the selected fiber raw material is the sintering temperature or above in the production method, the selected fiber raw materials can pact as a framework;
(2) the particle size of the glass powder is 10 μm or less, optionally, the particle size is 3000 meshes or less;
(3) the fiber component is at least one of silicon carbide fiber, silicon nitride fiber, aluminum silicate fiber, quartz fiber, mullite fiber, alumina fiber, hydroxyapatite fiber, and zirconium oxide fiber;
(4) the pore-forming agent is one or a mixture of carbon powder, polystyrene, polymethyl methacrylate, polylactic acid, polyvinyl alcohol, polyethylene terephthalate, engineering plastics, starch, cellulose, sawdust, and graphite powder which can be decomposed, volatilized or burned at high temperatures;
(5) the particle size of the pore-forming agent is 10-300 μm, optionally, the average particle size of the pore-forming agent is 70-90 μm, for example, about 80 μm. The porous glass material with better communication can be obtained by adjusting the addition ratio of pore-forming agents with different diameters.

Optionally, the heating unit in step S2 is a heating wire, a heating net or a heating film;
optionally, the heating wire or heating net needs to be embedded in the green body forming process, and is then sintered together with a formed body to obtain a porous glass atomization core;
optionally, as for the heating film, a thick film resistive heating film is printed by screen printing, or a thin film resistive heating film is formed by spraying or magnetron sputtering, the pattern of the heating film is designed, and then the porous glass atomization core is obtained through a sintering step.

This application further provides a porous glass atomization core, using the porous glass as a substrate of the porous glass atomization core, on which the heating unit is arranged.

In scheme a, the porosity of the porous glass is 50-70%, and the average pore size is 10-200 μm;
or, in scheme b, the porosity of the porous glass is 65-80%, and the average pore size is 10-200 μm, optionally, the average pore size is 70-90 μm.

Optionally, the porous glass in the scheme a is produced by the production method of the above-mentioned scheme one;
or the porous glass in the scheme b is produced by the production method of the above-mentioned scheme two.

Optionally, the porous glass in the scheme b includes a framework and multi-directional communication pores, the framework includes a fiber body and a glass body surrounding the fiber body, the average pore size of the multi-directional communication pores is 10-200 μm, and optionally, the average pore size is 70-90 μm. The pore size is generally determined by the size of the pore-forming agent and is comparable to the size of the pore-forming agent.

Optionally, the fiber body has a diameter of 3-30 μm and a length of 20-500 μm;
optionally, the fiber body has a diameter of 10-25 μm and a length of 20-150 μm.

Optionally, the aspect ratio of the fiber body is 1-10, optionally, the aspect ratio of fibers with a length of 50-150 μm in the fiber body is 2-5;
and/or, the proportion of fibers with a length of 50 μm or more in the fiber body is 25% or more, optionally, the proportion is 40% or more.

In the porous glass atomization core provided by this application, the porous glass substrate includes a framework and a multi-directional communication pores. The glass powder acts as an adhesive, and glass serves as a framework bonding point to bond with effective fibers coated or not coated with glass on the surfaces to form a three-dimensional structure; or glass-coated fiber particles become a framework bonding point to bond with the effective fibers coated or not coated with glass on the surfaces to form a three-dimensional structure. The surface of the formed framework structure (the surface of the porous glass material and internal pore walls) is smooth and continuous, and has no microporous secondary structure.

In this application, if the diameter and length of the fiber component are not within the above ranges, the fiber component needs to be preprocessed to the above sizes.

Typically, but not limiting, glass powder and fiber component pore-forming agents with specific diameters and lengths can be obtained by ball milling and sieving. Specifically, the fiber component can be obtained by the following method:
cutting and sieving fiber raw materials first; weighting the cut and sieved fibers, a dispersing agent and a solvent, and performing high-energy ball milling; drying milled fibers, which are then sieved, then taking out the fibers under the sieve, and observing the diameter and length of the fibers under the sieve by a scanning electron microscope (SEM). The length and diameter of the fibers are controlled by process parameters, where the mesh size of the sieve for sieving the cut fibers is 10-40 meshes.

The dispersing agent include but is not limited to: stearic acid, oleic acid, paraffin, polyethylene glycol, and the like. The solvent includes but is not limited to: water, alcohol, ethyl acetate and the like.

The high-energy ball milling adopts planetary ball milling, the ball milling speed is 100-500 r/min, and the ball milling time is 0.5-5 h.

Typically, but not limiting, the mesh size of the sieve for sieving the dried fibers is 40-100 meshes (sieving only makes the fiber dispersion more uniform, the actual fiber mesh size is much lower than 40-100 meshes, and the laser particle size test result is about 15-100 μm).

According to the length and function of the fibers, the fibers can be divided into fiber particles less than 50 μm and effective fibers with a length of 50-150 μm for supporting, and the aspect ratio of the effective fibers is 2 or more. Preferably, the length of the effective fibers is 50-100 μm, and the aspect ratio of the effective fibers is 2-5; and the effective fibers are 25% or more of the total fiber mass. Preferably, the effective fibers are 40% or more of the total fiber mass.

Typically, but not limiting, in order to obtain glass powder with uniform particle size, commercially available glass powder can be ball-milled for 3-5 hours at a speed of 200-500 r/min by using a high-energy planetary ball mill with ethanol as a solvent, and then dried and sieved for use.

For the fiber component, generally, commercially available 2-5 mm chopped fibers are crushed to 0.5 mm or less by a crusher first, and then undergo high-energy planetary ball milling for 2-12 hours with ethanol as a solvent and stearic acid as a grinding aid at a ball milling speed of 100-400 r/min, preferably, at a ball milling speed of 300 r/min; and the ball-milled fibers are washed with ethanol, dried and sieved with a 100-mesh sieve to obtain target fibers. The proportion of the effective fibers to the total fiber mass can be changed by adjusting the ball milling time; generally, at a ball milling speed of 300 r/min, after 6 hours of ball milling, the effective fibers account for about 40% of the total fiber mass; after 8 hours of ball milling, the effective fibers account for about 30% of the total fiber mass; and after 12 hours or more of ball milling, the effective fiber accounts for about 10% or less of the total fiber mass. The grinding aid may also be oleic acid, paraffin, polyethylene glycol, and the like. The solvent may also be water or ethyl acetate, etc.

This application further provides an electronic atomizer, which includes the porous glass atomization core.

Typically, but not limiting, as shown in FIG. 8, the porous glass 1 is used as the substrate of the atomization core, a heating unit 2 is arranged on the substrate, and the heating unit is a heating wire, a heating net or a heating film. The heating wire or the heating net needs to be embedded in the green body forming process, and is then sintered together with a formed body to obtain the porous glass atomization core. When the heating film is adopted, a thick film resistive heating film may be printed on the porous glass substrate by screen printing, or a thin film resistive heating film may be formed by spraying or magnetron sputtering, the pattern of the heating film is designed, and then the porous glass atomization core can be obtained through a sintering step.

Typically, but not limiting, the thick film resistive heating film is produced by a screen printing technology. The thick film includes main components such as nickel-based alloys, iron-based alloys, silver alloys, titanium alloys, aluminum alloys, stainless steel, and the like, and contains elements such as Fe, Cr, Ni, Ti, Pa, Pt, Al, Mo, Si, Ag, and the like. The protruding thickness of the thick film is 11-100 μm, the infiltration thickness is 10-100 μm, the line width is 250-450 μm, the line spacing is 300-900 μm, and the patterns used are S, M, Q, and the like. The sintering temperature of the heating film is 700-1200° C., and the sintering time is 0.5-3 h.

Typically, but not limiting, the thin film resistive heating film is produced by spraying or magnetron sputtering. The thin film includes main components such as nickel-based alloys, silver alloys, titanium alloys, aluminum alloys, stainless steel and the like, and contains elements such as Fe, Cr, Ni, Ti, Pa, Pt, Al, Mo, Si, Ag, and the like. The protruding thickness of the thin film is 0.5-5 μm.

For example, a porous glass atomization core produced by sintering a porous glass material printed film has a heating unit that is a porous heating film. The porous heating film includes a portion higher than the surface of the porous glass substrate and a portion penetrating into the porous glass substrate. The portion higher than the surface of the porous glass substrate is of a porous structure with a pore size of 5-30 μm, pores are communication with each other and with substrate pores, and the height is 30-100 μm, preferably about 60 μm; the heating film of the portion penetrating into the porous glass substrate has a maximum penetration thickness of about 170 μm, and is embedded in porous channels of the porous substrate, so that the entire porous heating film is firmly combined with the porous glass substrate. The resistance of the heating film is 0.8-1.2 ohms.

The technical solution of this application has the following advantages:
according to the porous glass atomization core provided by this application, the porous glass is used as the substrate; the heating unit is arranged on the substrate; and the porous glass has a porosity of 50-80% and a pore size of 10-200 μm. Compared with porous ceramics, the porous glass has a smooth and continuous surface, which can be well adapted to the thin-film heating film and improve the stability of the thin-film heating film. According to this application, the porosity and pore size of the porous glass are limited, and thus the adsorption of low-viscosity components in the atomizing medium by the porous glass substrate can be reduced, and the taste and aroma reduction degree of the electronic atomizer are improved by using the porous glass as the substrate of the heating unit in the atomization core.

The porosity of the porous glass for the porous glass atomization core provided by this application is 65-80%, and the average pore size is 10-200 μm, optionally, the average pore size is 70-90 μm. Generally, the porous glass and the porous ceramics are used as the substrate of the atomization core to store and transfer an atomization liquid medium. When the pore size of the substrate is relatively small, the atomization liquid medium passes slowly, which can easily lead to insufficient supply of the atomization liquid medium (e-liquid) and produce a burnt taste, and the like; and when the pore size of the substrate is too large, the porous substrate has poor liquid locking ability and leakage is likely to occur during the smoking process. The porous glass material provided by this application has a uniform pore size distribution and good communication between pores. The pores formed by mutually connect structures can be connected with multiple surrounding pores to form a multi-directional communication pore structure. The smooth porous pore walls reduce the viscous resistance when atomization substrates such as e-liquid pass through. The porous glass substrate has a large e-liquid storage capacity, a small tortuosity, and a fast e-liquid guiding rate. Compared with commercially available porous ceramic substrates, the e-liquid guiding rate of the porous glass substrate can be increased by 20% or more.

According to the production method for the porous glass atomization core provided by this application, by further limiting the diameter, length, aspect ratio and effective fiber proportion of the fiber component in the porous glass production process, the diameter, length, aspect ratio and the like of the fiber affect the porosity and strength of the porous glass substrate and the size of the pores; generally, an increase in the fiber diameter can reduce the porosity of the substrate; if the fiber diameter is too small, the fibers cannot play a supporting role, thereby resulting in the reduction of the strength of the substrate; if the fiber length is too large, it is easy to cause fiber bending in the substrate and incomplete stress release, which will also lead to low substrate strength, and the stress release during subsequent sintering and use will causes product failure; and if there are too few effective fibers, the substrate is not easily supported, and the porosity of the substrate is reduced.

According to the production method for the porous glass atomization core provided by this application, by limiting the debinding temperature and sintering temperature in the production process of the porous glass, the debinding and sintering process can significantly affect the pore size, pores and strength of the porous substrate; generally, the debinding temperature can be selected through the thermodynamic properties of additives (pore-forming agents, auxiliaries, and the like), so that the additives in the green body can be slowly discharged in the debinding process; if the debinding time is too short, the product quality will be affected, and the product will bubble or crack; and if the debinding time is too long, the production efficiency will be affected. Generally, the sintering temperature and time also affect the final performance of the product. According to this application, the sintering temperature and sintering time are set according to the softening point of selected glass materials. Too high sintering temperature will cause the product to collapse during sintering, while too low sintering temperature will cause incomplete melting of glass, resulting in accumulation of glass powder in pores and low sample strength.

The porous glass substrate of the porous glass atomization core provided by this application includes the following mass percent of components by the total mass of the raw materials: 20-80% of glass powder; 5-50% of fiber component; 10-70% of pore-forming agent; and 0-50% of additive phase. According to this application, with the glass powder as the main component and the fiber component as the framework, the pore structure collapse caused by the softening and flow of glass is prevented, and the pore structure of the porous glass is guaranteed to a great extent. The produced porous glass has the characteristics of high porosity (50-80%), appropriate pore size (10-200 μm), and smooth and continuous internal surface, which can reduce the adsorption of low-viscosity components in atomizing mediums by the porous substrate, ensure the full atomization of atomizing medium components; and as the substrate of the heating element in the atomization core, the porous glass improves the taste and aroma reduction degree of the electronic atomizer. The production method for the porous glass provided by this application can also reduce the addition of harmful substances and improve the safety performance of the product by limiting the raw material components.

The porous glass atomization core provided by this application has a through, smooth and continuous pore structure. Compared with the porous ceramic heating core, the porous glass atomization core has smaller e-liquid guiding resistance and faster e-liquid guiding rate, thereby ensuring sufficient e-liquid supply during the atomization process, improving the atomization capability of the atomization core, and increasing the aerosol amount and nicotine satisfaction. At the same time, attribute to the rapid e-liquid supply capability, the atomization temperature is relatively low, the temperature is uniform during the atomization process, there is no local high-temperature atomization point, and harmful substances such as aldehydes and ketones in flue gas generated by excessively high atomization temperature are reduced, thereby improving the product safety; and the same time, the occurrence of carbon deposition, scorching and other failures during product smoking is reduced.

### LIST OF REFERENCE NUMERALS

1. Porous glass; and 2. Heating unit.

The following examples are provided for a better understanding of this application, but are not limited to the best implementation described, and do not limit the content and protection scope of this application. Any product identical or similar to this application obtained by anyone under the inspiration of this application or by combining the features of this application with other prior arts shall fall within the protection scope of this application.

If no specific experimental steps or conditions are specified in the examples, the experiments can be carried out according to the conventional experimental steps or conditions described in the literature in the art. Reagents or instruments used without indicating manufacturers are all conventional reagents that can be purchased from the market.

### EXAMPLE 1

The present example provides a porous glass atomization core, a production method of which includes the following steps:
Mullite fibers are cut first, the cut mullite fibers are sieved with a 20-mesh sieve, 100 g of sieved mullite fibers, 5 g of stearic acid, and 100 g of alcohol with a volume concentration of 100% are weighed, and planetary ball milling is performed, where the ball-to-material ratio is 3:1, the ball milling speed is 300 r/min, and the ball milling time is 30 min. The milled mullite fibers are dried in an oven at the temperature of 100° C., and then the fibers are sieved by using a 40-mesh sieve.
35 g of 3000-mesh glass powder (softening temperature 1080° C., the same below), 40 g of 50 μm PMMA pore-forming agent, and 25 g of ball-milled and sieved mullite fibers are weighed according to mass, and mixed for 2 h by using a three-dimensional mixer. A green body is produced by injection molding.

The green body debinding process is as follows: debinding is performed in this temperature range: raising the room temperature to 200° C. at a uniform speed for 3 hours, and keeping the temperature at 200° C. for 3 hours; raising the temperature to 250° C. from 200° C. at a uniform speed for 3 hours, and keeping the temperature at 250° C. for 3 hours; raising the temperature to 300° C. from 250° C. at a uniform speed for 3 hours, and keeping the temperature at 300° C. for 3 hours; raising the temperature to 350° C. from 300° C. at a uniform speed for 3 hours, and keeping the temperature at 350° C. for 3 hours; raising the temperature to 600° C. from 350° C. at a uniform speed for 4 hours, and keeping the temperature at 600° C. for 2 hours. The sintering temperature is 1100° C., and the sintering time is 60 min. The size of the green body after sintering is 4×9×4.4, and the shape is shown in FIG. 8. The pore structure of the obtained porous glass is shown in FIG. 1.

A thick film resistive heating film is printed on the porous glass substrate by screen printing, using nickel-based alloy (specifically includes elements such as nickel, iron, chromium, copper and molybdenum). The protruding thickness of the thick film is about 60 μm, and the infiltration thickness is about 30 μm. The pattern is shown in FIG. 8. The line width is 300 μm, the line spacing is 600 μm, the sintering temperature is 1000° C., and the time is 30 min. In this way, the atomization core is obtained.

### EXAMPLE 2

The present example provides a porous glass atomization core, a production method of which includes the following steps:
alumina fibers are cut first, the cut alumina fibers are sieved with a 10-mesh sieve, 100 g of sieved alumina fibers, 3 g of stearic acid, and 100 g of alcohol with a volume concentration of 100% are weighed, and planetary ball milling is performed, where the ball-to-material ratio is 6:1, the ball milling speed is 400 r/min, and the ball milling time is 60 min. The milled alumina fibers are dried in an oven at the temperature of 100° C., and then the fibers are sieved by using a 40-mesh sieve.
35 g of 3000-mesh glass powder, 40 g of 100 μm ASA pore-forming agent, and 25 g of ball-milled and sieved alumina fibers are weighed according to mass, and mixed for 3 h by using a three-dimensional mixer. A green body is produced by an injection molding process.

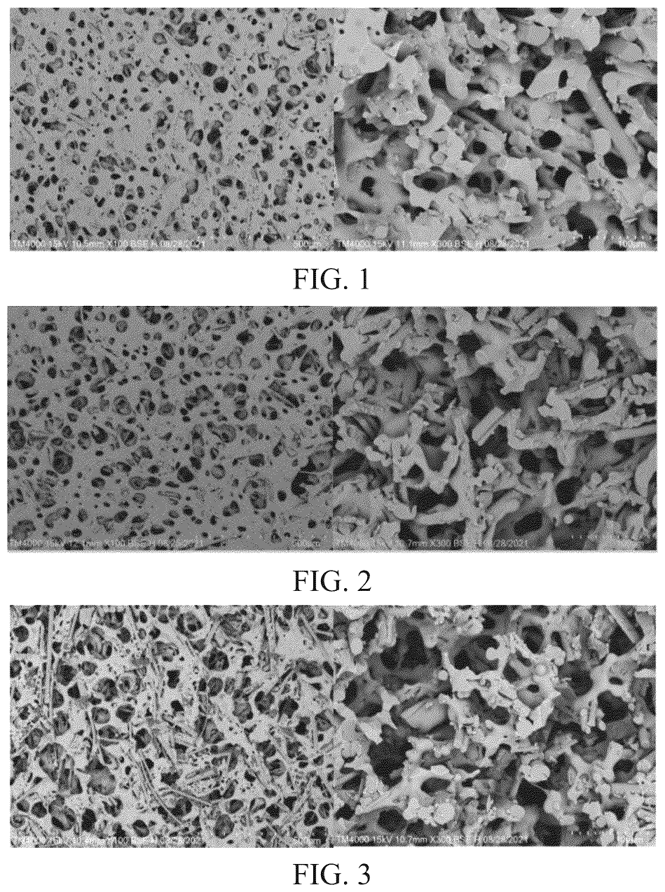

The green body debinding process is as follows: debinding is performed in this temperature range: raising the room temperature to 200° C. at a uniform speed for 4 hours, and keeping the temperature at 200° C. for 4 hours; raising the temperature to 250° C. from 200° C. at a uniform speed for 4 hours, and keeping the temperature at 250° C. for 4 hours; raising the temperature to 300° C. from 250° C. at a uniform speed for 4 hours, and keeping the temperature at 300° C. for 4 hours; raising the temperature to 350° C. from 300° C. at a uniform speed for 4 hours, and keeping the temperature at 350° C. for 4 hours; raising the temperature to 700° C. from 350° C. at a uniform speed for 6 hours, and keeping the temperature at 700° C. for 2 hours. The sintering temperature is 1100° C., and the sintering time is 30 min. The size of the green body after sintering is 4×9×4.4, and the shape is shown in FIG. 8. The pore structure of the obtained porous glass is shown in FIG. 2.

A thick film resistive heating film is printed on the porous glass substrate by screen printing, using nickel-based alloy (specifically includes elements such as nickel, iron, chromium, copper and molybdenum). The protruding thickness of the thick film is about 60 μm, and the infiltration thickness is about 30 μm. The pattern is shown in FIG. 8. The line width is 300 μm, the line spacing is 600 μm, the sintering temperature is 1000° C., and the time is 30 min. In this way, the atomization core is obtained.

### EXAMPLE 3

The present example provides a porous glass atomization core, a production method of which includes the following steps:
Aluminum silicate fibers are cut first, the aluminum silicate fibers are sieved with a 40-mesh sieve, 100 g of sieved aluminum silicate fibers, 10 g of stearic acid, and 100 g of alcohol with a volume concentration of 100% are weighed, and planetary ball milling is performed, where the ball-to-material ratio is 5:1, the ball milling speed is 400 r/min, and the ball milling time is 2 h. The milled aluminum silicate fibers are dried in an oven at the temperature of 100° C., and then the fibers are sieved by using a 60-mesh sieve.
35 g of 3000-mesh glass powder, 40 g of 200 μm PET pore-forming agent, and 25 g of ball-milled and sieved aluminum silicate fibers are weighed according to mass, and mixed for 3 h by using a three-dimensional mixer. A green body is produced by injection molding. The green body debinding process is as follows: raising the room temperature to 200° C. at a uniform speed for 4 hours, and keeping the temperature at 200° C. for 5 hours; raising the temperature to 250° C. from 200° C. at a uniform speed for 6 hours, and keeping the temperature at 250° C. for 6 hours; raising the temperature to 300° C. from 250° C. at a uniform speed for 5 hours, and keeping the temperature at 300° C. for 6 hours; raising the temperature to 350° C. from 300° C. at a uniform speed for 6 hours, and keeping the temperature at 350° C. for 4 hours; raising the temperature to 700° C. from 350° C. at a uniform speed for 6 hours, and keeping the temperature at 700° C. for 2 hours. The sintering time is 1100° C., and the sintering time is 60 min. The size of the green body after sintering is 4×9×4.4, and the shape is shown in FIG. 8. The pore structure of the obtained porous glass is shown in FIG. 3.

A thick film resistive heating film is printed on the porous glass substrate by screen printing, using nickel-based alloy (specifically includes elements such as nickel, iron, chromium, copper and molybdenum). The protruding thickness of the thick film is about 60 μm, and the infiltration thickness is about 30 μm. The pattern is shown in FIG. 8. The line width is 300 μm, the line spacing is 600 μm, the sintering temperature is 1000° C., and the time is 30 min. In this way, the atomization core is obtained.

### EXAMPLE 4

The present example provides a porous glass atomization core, a production method of which includes the following steps:
Alumina fibers are cut first, the cut alumina fibers are sieved with a 10-mesh sieve, 100 g of sieved alumina fibers, 3 g of stearic acid, and 100 g of alcohol with a volume concentration of 100% are weighed, and planetary ball milling is performed, where the ball-to-material ratio is 6:1, the ball milling speed is 400 r/min, and the ball milling time is 60 min. the milled alumina fibers are dried in an oven at the temperature of 100° C., and then the fibers are sieved by using a 40-mesh sieve.
20 g of 3000-mesh glass powder, 30 g of 100 μm ASA pore-forming agent, and 50 g of ball-milled and sieved alumina fibers are weighed according to mass, and mixed for 3 h by using a three-dimensional mixer. A green body is produced by an injection molding process. The green body debinding process is as follows: debinding is performed in this temperature range: raising the room temperature to 200° C. at a uniform speed for 4 hours, and keeping the temperature at 200° C. for 4 hours; raising the temperature to 250° C. from 200° C. at a uniform speed for 4 hours, and keeping the temperature at 250° C. for 4 hours; raising the temperature to 300° C. from 250° C. at a uniform speed for 4 hours, and keeping the temperature at 300° C. for 4 hours; raising the temperature to 350° C. from 300° C. at a uniform speed for 4 hours, and keeping the temperature at 350° C. for 4 hours; raising the temperature to 700° C. from 350° C. at a uniform speed for 6 hours, and keeping the temperature at 700° C. for 2 hours. The sintering temperature is 1000° C., and the sintering time is 30 min. The size of the green body after sintering is 4×9×4.4, and the shape is shown in FIG. 8. The pore structure of the obtained porous glass is shown in FIG. 4.

A thick film resistive heating film is printed on the porous glass substrate by screen printing, using nickel-based alloy (specifically includes elements such as nickel, iron, chromium, copper and molybdenum). The protruding thickness of the thick film is about 60 μm, and the infiltration thickness is about 30 μm. The pattern is shown in FIG. 8. The line width is 300 μm, the line spacing is 600 μm, the sintering temperature is 1000° C., and the time is 30 min. In this way, the atomization core is obtained.

### EXAMPLE 5

The present example provides a porous glass atomization core, a production method of which includes the following steps:
alumina fibers are cut first, the cut alumina fibers are sieved with a 10-mesh sieve, 100 g of sieved alumina fibers, 3 g of stearic acid, and 100 g of alcohol with a volume concentration of 100% are weighed, and planetary ball milling is performed, where the ball-to-material ratio is 6:1, the ball milling speed is 400 r/min, and the ball milling time is 60 min. the milled alumina fibers are dried in an oven at the temperature of 100° C., and then the fibers are sieved by using a 40-mesh sieve.
80 g of 3000-mesh glass powder, 15 g of 100 μm ASA pore-forming agent, and 5 g of ball-milled and sieved alumina fibers are weighed according to mass, and mixed for 3 h by using a three-dimensional mixer. A green body is produced by an injection molding process.

The green body debinding process is as follows: debinding is performed in this temperature range: raising the room temperature to 200° C. at a uniform speed for 4 hours, and keeping the temperature at 200° C. for 4 hours; raising the temperature to 250° C. from 200° C. at a uniform speed for 4 hours, and keeping the temperature at 250° C. for 4 hours; raising the temperature to 300° C. from 250° C. at a uniform speed for 4 hours, and keeping the temperature at 300° C. for 4 hours; raising the temperature to 350° C. from 300° C. at a uniform speed for 4 hours, and keeping the temperature at 350° C. for 4 hours; raising the temperature to 700° C. from 350° C. at a uniform speed for 6 hours, and keeping the temperature at 700° C. for 2 hours. The sintering temperature is 1000° C., and the sintering time is 30 min. The size of the green body after sintering is 4×9×4.4, and the shape is shown in FIG. 8. The pore structure of the obtained porous glass is shown in FIG. 5.

A thick film resistive heating film is printed on the porous glass substrate by screen printing, using nickel-based alloy (specifically includes elements such as nickel, iron, chromium, copper and molybdenum). The protruding thickness of the thick film is about 70 μm, and the infiltration thickness is about 20 μm. The pattern is shown in FIG. 8. The line width is 300 μm, the line spacing is 600 μm, the sintering temperature is 1000° C., and the time is 30 min. In this way, the atomization core is obtained.

### EXAMPLE 6

The present example provides a porous glass atomization core, a production method of which includes the following steps:
alumina fibers are cut first, the cut alumina fibers are sieved with a 10-mesh sieve, 100 g of sieved alumina fibers, 3 g of stearic acid, and 100 g of alcohol with a volume concentration of 100% are weighed, and planetary ball milling is performed, where the ball-to-material ratio is 6:1, the ball milling speed is 400 r/min, and the ball milling time is 60 min. The milled alumina fibers are dried in an oven at the temperature of 100° C., and then the fibers are sieved by using a 40-mesh sieve.
35 g of 3000-mesh glass powder, 40 g of 100 μm ASA pore-forming agent, and 20 g of ball-milled and sieved alumina fibers are weighed according to mass, 5 g of zeolite powder of about 30 μm is added, and mixed for 3 h by using a three-dimensional mixer. A green body is produced by an injection molding process.

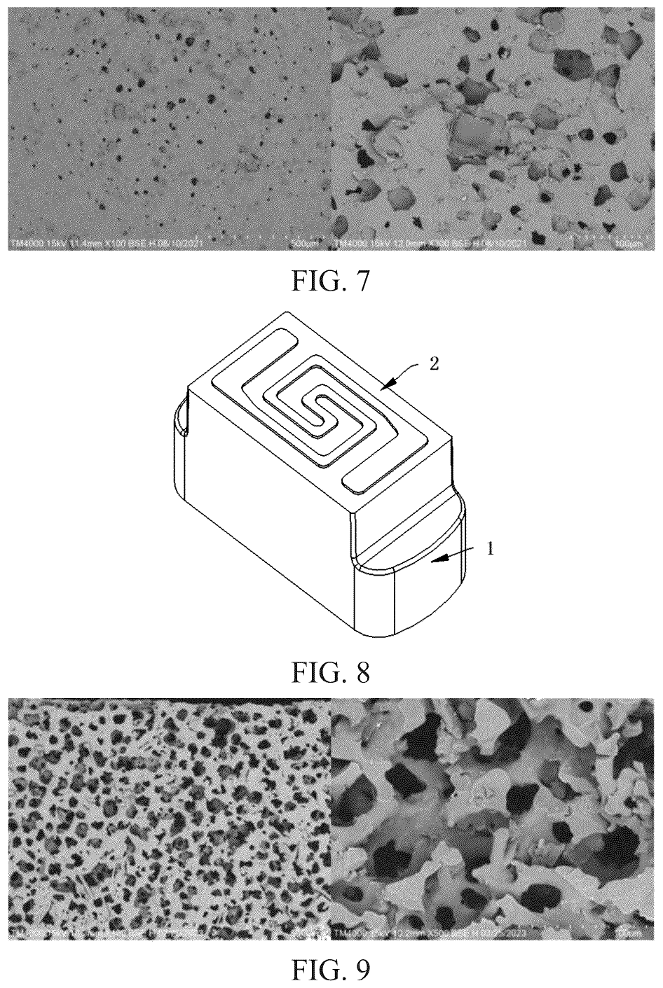

The green body debinding process is as follows: debinding is performed in this temperature range: raising the room temperature to 200° C. at a uniform speed for 4 hours, and keeping the temperature at 200° C. for 4 hours; raising the temperature to 250° C. from 200° C. at a uniform speed for 4 hours, and keeping the temperature at 250° C. for 4 hours; raising the temperature to 300° C. from 250° C. at a uniform speed for 4 hours, and keeping the temperature at 300° C. for 4 hours; raising the temperature to 350° C. from 300° C. at a uniform speed for 4 hours, and keeping the temperature at 350° C. for 4 hours; raising the temperature to 700° C. from 350° C. at a uniform speed for 6 hours, and keeping the temperature at 700° C. for 2 hours. The sintering temperature is 1100° C., and the sintering time is 30 min. The size of the green body after sintering is 4×9×4.4, and the shape is shown in FIG. 8. The pore structure of the obtained porous glass is shown in FIG. 7.

A thick film resistive heating film is printed on the porous glass substrate by screen printing, using nickel-based alloy (specifically includes elements such as nickel, iron, chromium, copper and molybdenum). The protruding thickness of the thick film is about 60 μm, and the infiltration thickness is about 30 μm. The pattern is shown in FIG. 8. The line width is 300 μm, the line spacing is 600 μm, the sintering temperature is 1000° C., and the time is 30 min. In this way, the atomization core is obtained.

### EXAMPLE 7

The present example provides a porous glass atomization core, a production method of which includes the following steps:
Raw material processing: performing ball milling on glass powder by using ethanol as a solvent in a planetary ball mill at a speed of 300 r/min for 3 hours, drying, and sieving the ball-milled glass powder to obtain glass powder with a particle size of 3-5 μm (the same below); performing planetary ball milling on crushed mullite chopped fibers for 6 hours by using stearic acid as a grinding aid and ethanol as a solvent at a speed of 300 r/min, drying after washing with ethanol, and sieving with a 100-mesh sieve to obtain fiber raw materials, where effective fibers accounts for 40% of the total fiber mass, and the aspect ratio of the effective fibers is 2-5.

Ingredient molding: preparing 48 g of glass powder, 52 g of mullite fibers and 100 g of PMMA (80 μm) pore-forming agent, mixing the materials in a three-dimensional mixer for 2 hours, adding the mixed materials into an internal mixer, and adding paraffin wax accounting for 20% of the mass of the mixed materials, polyethylene accounting for 5% of the mass of the mixed materials, and a dispersing aid (stearic acid or dibutyl phthalate, and dibutyl phthalate is used in the present example, the same below) accounting for 5% of the mass of the mixed materials, performing airtight mixing at the temperature of 180° C. for 2 hours, and then producing a green body through an injection molding machine.

Debinding and sintering: raising the temperature to 200° C. in 200 minutes, and then raising to 500° C. at 0.5° C. per minute, where a 2-hour temperature preservation time is set at 240° C., 280° C., 300° C., and 350° C. respectively, then raising the temperature to 1180° C. at 5° C. per minute, keeping the temperature for 30 minutes, and naturally cooling to the room temperature to obtain a porous glass material with a fiber content of 52%, where the micro-morphology of the porous glass is shown in FIG. 9.

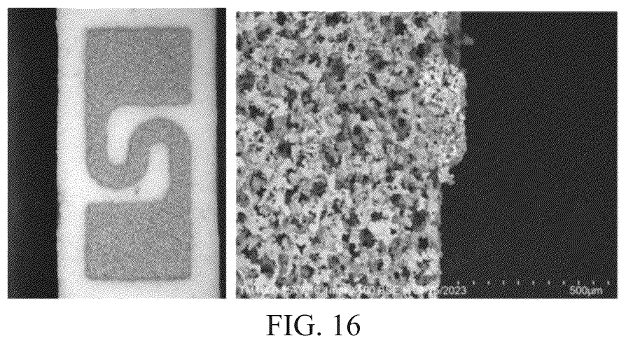

Heating film production: producing the atomization core by using a produced porous glass substrate, performing film printing and sintering by adopting ruthenium-based porous thick film heating film slurry with ruthenium dioxide (containing trace amounts of Ag, Cu, Ni, and Bi elements) as a main component to obtain a porous heating membrane, where the pore size of the porous heating film is 5-30 μm, the pores are communicated with each other and with pores of the substrate, the porous heating film is about 80 μm higher than the substrate and has a penetration thickness of about 70 μm, the pattern is shown in FIG. 16, the line width is about 330 μm, the line spacing is about 650 μm, the line is about 800 μm away from the edge of the substrate, the sintering temperature is 980° C., and the time is 30 min, and thus, the porous glass atomization core is obtained.

### EXAMPLE 8

The present example provides a porous glass atomization core, a production method of which includes the following steps:
Raw material processing: the same as example 7.
Ingredient molding: preparing 40 g of glass powder, 60 g of fibers and 200 g of PMMA (80 μm) pore-forming agent, mixing the materials in a three-dimensional mixer for 2 hours, adding the mixed materials into an internal mixer, and adding paraffin wax accounting for 20% of the mass of the mixed materials, polyethylene accounting for 5% of the mass of the mixed materials, and a dispersing aid accounting for 5% of the mass of the mixed materials, performing airtight mixing at the temperature of 180° C. for 2 hours, and then producing a green body through an injection molding machine.

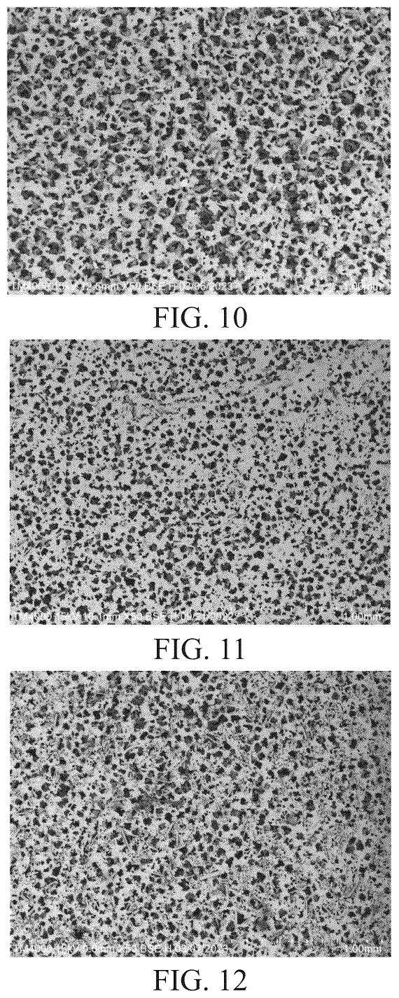

Debinding and sintering: raising the temperature to 200° C. in 200 minutes, and then raising to 500° C. at 0.5° C. per minute, where a 2-hour temperature preservation time is set at 240° C., 280° C., 300° C., and 350° C. respectively, then raising the temperature to 1220° C. at 5° C. per minute, keeping the temperature for 30 minutes, and naturally cooling to the room temperature to obtain the porous glass material with a fiber content of 60%, where the micro-morphology of the porous glass substrate is shown in FIG. 10.

The production method for the heating film is the same as Example 7.

### EXAMPLE 9

The present example provides a porous glass atomization core, a production method of which includes the following steps:
Raw material processing: performing ball milling on glass powder by using ethanol as a solvent in a planetary ball mill at a speed of 300 r/min for 3 hours, drying, and sieving the ball-milled glass powder to obtain glass powder with a particle size of 3-5 μm; performing planetary ball milling on crushed mullite chopped fibers for 8 hours by using stearic acid as a grinding aid and ethanol as a solvent at a speed of 300 r/min, drying after washing with ethanol, and sieving with a 100-mesh sieve to obtain fiber raw materials, where effective fibers accounts for 25% of the total fiber mass, and the aspect ratio of the effective fibers is 2-5.
Ingredient molding: preparing 62 g of glass powder, 38 g of mullite fibers and 240 g of PMMA (80 μm) pore-forming agent, mixing the materials in a three-dimensional mixer for 2 hours, adding the mixed materials into an internal mixer, and adding paraffin wax accounting for 20% of the mass of the mixed materials, polyethylene accounting for 5% of the mass of the mixed materials, and a dispersing aid accounting for 5% of the mass of the mixed materials, performing airtight mixing at the temperature of 180° C. for 2 hours, and then producing the green body through the injection molding machine.
Debinding and sintering: raising the temperature to 200° C. in 200 minutes, and then raising to 500° C. at 0.5° C. per minute, where a 2-hour temperature preservation time is set at 240° C., 280° C., 300° C., and 350° C. respectively, then raising the temperature to 1200° C. at 5° C. per minute, keeping the temperature for 30 minutes, and naturally cooling to the room temperature to obtain a porous glass material with a fiber content of 38%, where the micro-morphology of the porous glass is shown in FIG. 11.

The production method for the heating film is the same as Example 7.

### EXAMPLE 10

The present example provides a porous glass atomization core, a production method of which includes the following steps:
Raw material processing: performing ball milling on glass powder by using ethanol as a solvent in a planetary ball mill at a speed of 300 r/min for 3 hours, drying, and sieving the ball-milled glass powder to obtain glass powder with a particle size of 3-5 μm; performing planetary ball milling on crushed mullite chopped fibers for 12 hours by using the stearic acid as the grinding aid and the ethanol as the solvent at a speed of 300 r/min, drying after washing with the ethanol, and sieving with the 100-mesh sieve to obtain the fiber raw materials, where effective fibers accounts for 10% of the total fiber mass, and the aspect ratio of the effective fibers is 2-5.
Ingredient molding: preparing 62 g of glass powder, 38 g of mullite fibers and 240 g of PMMA (80 μm) pore-forming agent, mixing the materials in a three-dimensional mixer for 2 hours, adding the mixed materials into an internal mixer, and adding paraffin wax accounting for 20% of the mass of the mixed materials, polyethylene accounting for 5% of the mass of the mixed materials, and a dispersing aid accounting for 5% of the mass of the mixed materials, performing airtight mixing at the temperature of 180° C. for 2 hours, and then producing the green body through the injection molding machine.
Debinding and sintering: raising the temperature to 200° C. in 200 minutes, and then raising to 500° C. at 0.5° C. per minute, where a 2-hour temperature preservation time is set at 240° C., 280° C., 300° C., and 350° C. respectively, then raising the temperature to 1250° C. at 5° C. per minute, keeping the temperature for 30 minutes, and naturally cooling to the room temperature to obtain a porous glass material with a fiber content of 38%, where the micro-morphology of the porous glass is shown in FIG. 12.

The production method for the heating film is the same as Example 7. After testing, the resistance of the heating film obtained in Examples 7-10 is 0.8-1.2 ohms.

### COMPARATIVE EXAMPLE 1

The comparative example provides an atomization core, a production method of which includes the following steps:
60 g of glass powder and 40 g of 100 μm ASA pore-forming agent are weighed according to mass, and mixed for 3 h by using the three-dimensional mixer. A green body is produced by injection molding.

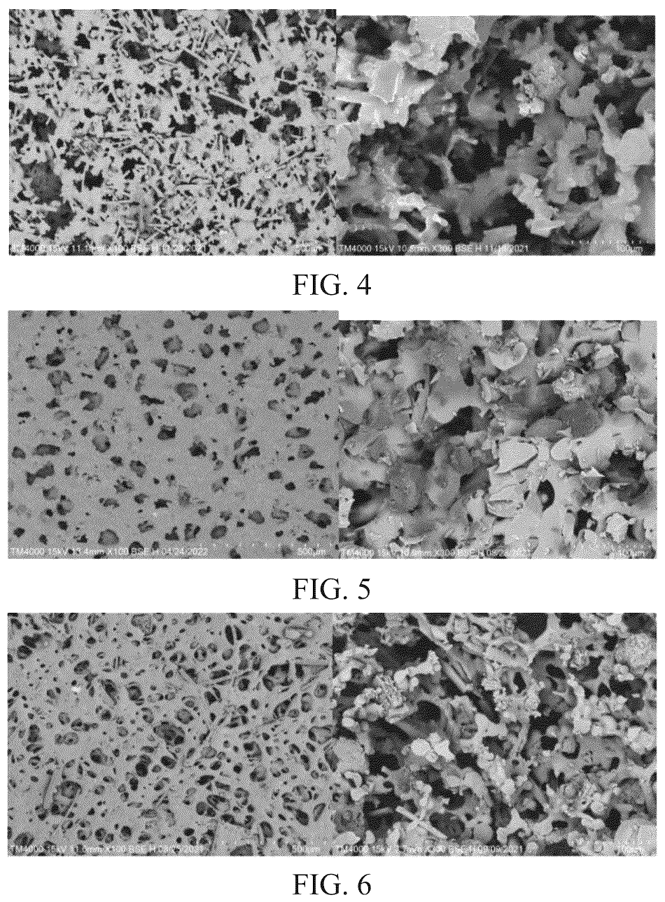

The green body debinding process is as follows: debinding is performed in this temperature range: raising the room temperature to 200° C. at a uniform speed for 4 hours, and keeping the temperature at 200° C. for 4 hours; raising the temperature to 250° C. from 200° C. at a uniform speed for 4 hours, and keeping the temperature at 250° C. for 4 hours; raising the temperature to 300° C. from 250° C. at a uniform speed for 4 hours, and keeping the temperature at 300° C. for 4 hours; raising the temperature to 350° C. from 300° C. at a uniform speed for 4 hours, and keeping the temperature at 350° C. for 4 hours; raising the temperature to 700° C. from 350° C. at a uniform speed for 6 hours, and keeping the temperature at 700° C. for 2 hours. The sintering temperature is 1100° C., and the sintering time is 30 min. The size of the green body after sintering is 4×9×4.4, and the shape is shown in FIG. 8. The sintering temperature is 1100° C. The sintering time is 60 min. The pore structure of the obtained porous glass is shown in FIG. 6.

A thick film resistive heating film is printed on the porous glass substrate by screen printing, using nickel-based alloy (specifically includes elements such as nickel, iron, chromium, copper and molybdenum). The protruding thickness of the thick film is about 60 μm, and the infiltration thickness is about 30 μm. The pattern is shown in FIG. 8. The line width is 300 μm, the line spacing is 600 μm, the sintering temperature is 1000° C., and the time is 30 min. In this way, the atomization core is obtained.

### COMPARATIVE EXAMPLE 2

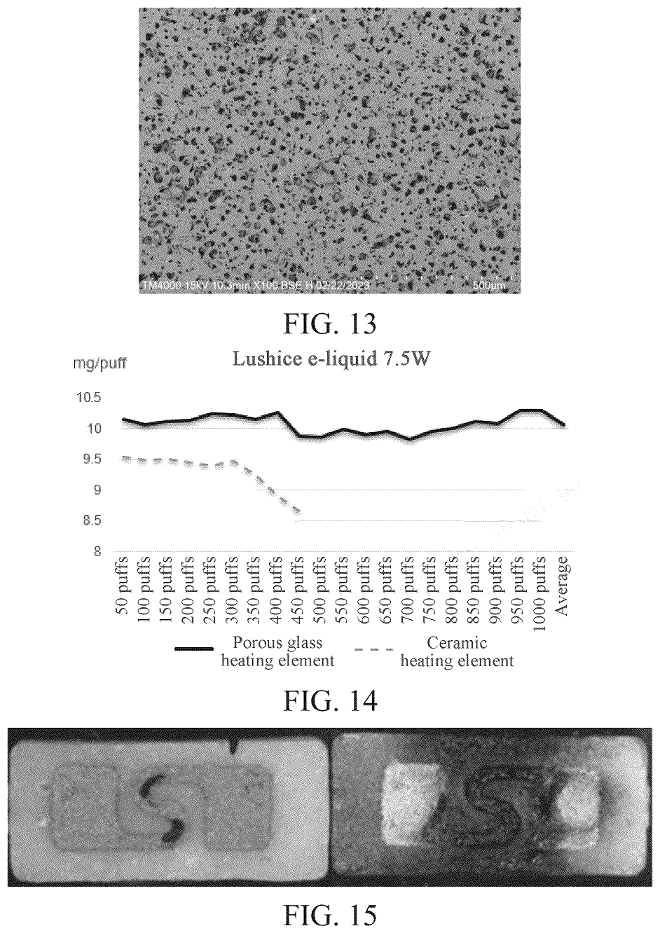

The present comparative example provides a porous glass atomization core, a production method of which includes the following steps:
Raw material processing: the same as example 10.
Ingredient molding: preparing 70 g of glass powder, 30 g of mullite fibers and 200 g of PMMA (80 μm) pore-forming agent, mixing the materials in the three-dimensional mixer for 2 hours, adding the mixed materials into an internal mixer, and adding paraffin wax accounting for 20% of the mass of the mixed materials, polyethylene accounting for 5% of the mass of the mixed materials, and a dispersing aid accounting for 5% of the mass of the mixed materials, performing airtight mixing at the temperature of 180° C. for 2 hours, and then producing the green body through the injection molding machine.
Debinding and sintering: raising the temperature to 200° C. in 200 minutes, and then raising to 500° C. at 0.5° C. per minute, where a 2-hour temperature preservation time is set at 240° C., 280° C., 300° C., and 350° C. respectively, then raising the temperature to 1320° C. at 5° C. per minute, keeping the temperature for 30 minutes, and naturally cooling to the room temperature to obtain a porous glass material with a fiber content of 30%, where the micro-morphology of the porous glass is shown in FIG. 13.

The production method for the heating film is the same as Example 7.

### TEST EXAMPLE

### 1. Porosity and Pore Size Test

According to this application, a drainage method is used for testing the porosity. The dry weight M₀ of the porous glass is weighed first, and then the porous glass is placed in a container and submerged with deionized water. A vacuum drying oven is used for vacuumizing for about 20 min to remove the water on the surface of the porous glass. The wet weight M₁ is weighed, then the porous glass is placed in deionized water, and the floating weight M₂ is weighed. The porosity is obtained by the following formula. Three samples from the same batch are tested and the average value is taken.

$$P = \frac{{M}_{1} - {M}_{0}}{{M}_{1} - {M}_{1}} .$$

According to this application, an aperture analyzer (bubble point meter) is used for testing the pore size, and based on this, the pore size distribution of the porous glass is determined.

Nitrogen is used for continuously applying pressure to the high-pressure side of the porous glass. When the gas on one side of the sample passes through the sample and reaches infiltration liquid on the other side, bubbles are generated. The maximum pore size of the sample is calculated by this method. By increasing the pressure, smaller pore sizes can be tested. The formula is as follows:

$${d}_{max} = 4 γ cos θ / Δ P$$

where dₘₐₓ is the maximum pore size, γ is the surface tension of wetting liquid, θ is the contact angle between the wetting liquid and the material to be tested, and delta P is the gas pressure difference on both sides of a sample to be tested.

The average pore size is taken as the reference value, and the air pressure test range is 0-300 KPa. Reference standards are GB/T 5249-1985 and ISO 4003-1977.

According to this test method, the “bubble test” method is used for testing. According to the test principle thereof, the pore size data obtained by the test is actually the diameter data of the pore throats of the multi-directional communication pores in the porous glass substrate.

### 2. E-liquid Guiding Rate

According to this application, the same atomizing medium is used for testing e-liquid guiding rate. 1 g of mixed solvent of glycerol (VG) and propylene glycol (PG) is weighed, where PG:VG=1:1, the mixed solvent is dropwise added into a container with a diameter of 2 mm, and the liquid level of the solvent is about 1-3 mm lower than the height of the porous sample. After the container is placed under an optical microscope and the porous substrate is placed in the center of the container, the timing is started; and the timing is stopped after observing through the optical microscope that the upper surface of the porous sample is fully filled with the solvent.

### 3. Tasting Test

Taste tasting: a taste tasting group consisting of five people conducts sensory evaluation respectively. The taste evaluation standards mainly include the following evaluation indicators: aroma concentration, irritation (miscellaneous gas), smoke volume, sweetness, throat hit, smoke humidity, aroma reduction degree and satisfaction. The maximum score for each evaluation indicator is 10 points, and each evaluation indicator is scored in units of 0.5 point. Except for irritation (miscellaneous gas) which is negatively scored, the other indicators are positively scored.

The meaning of 8 indicators is: aroma concentration, referring to the perceived richness of the overall aerosol in the nasal and oral cavities; irritation, referring to the irritation sensory experience of smoke after atomization of the atomizing medium in the mouth, throat, and nasal cavity, such as granularity, tingling, and miscellaneous gas; aerosol volume, referring to the total amount of aerosol formed after the atomizing medium is atomized, as well as the amount of aerosol felt through the mouth and visually observed after exhalation; sweetness, referring to the intensity of the sweet taste perceived in the oral cavity and the intensity of the sweet fragrance felt in the nasal cavity after the atomizing medium is atomized; throat hit, referring to the physical sensory intensity of the aerosol hitting the throat after inhalation of the aerosol; aerosol humidity, referring to the degree of wetness or dryness of aerosol particle droplet molecules sensed by the oral and nasal cavities; aroma reduction degree, referring to the mixing uniformity and coordination of the aroma after the atomizing medium is atomized; satisfaction, referring to the short-term brain excitement caused by nicotine being absorbed by the lungs in the same number of puffs, which can be symptoms such as numbness and dizziness in the head.

TABLE 1
EVALUATION STANDARDS

| | | | | | | Aroma | |
|---|---|---|---|---|---|---|---|
| Aroma | | Aerosol | | | Aerosol | reduction | |
| concentration | Irritation | volume | Sweetness | Throat hit | humidity | degree | Satisfaction |
| Rich and full | None 10 | Much, ≥8 | Intense | Strong, ≥8 | Wet 10 | Very good | Intense |
| 10 | | | 10 | | | 10 | 10 |
| Relatively | Tiny | More | Relatively | Relatively | Relatively | Good | Relatively |
| rich and full | 9-9.5 | 6-7.5 | intense | strong 6-7.5 | wet 7.5-9.5 | 7.5-9.5 | intense |
| 7.5-9.5 | | | 7.5-9.5 | | | | 7.5-9.5 |
| Not very rich | Slight | Moderate | Moderate | Moderate | Not very | Relatively | Moderate |
| and full 5.5-7 | 8-8.5 | 5-5.5 | 4.5-7 | 4.5-5.5 | wet 5.5-7 | good 5.5-7 | 4.5-7 |
| Weak aroma | Moderate | Less | Slight | Less | Not wet, 5 | Moderate | Slight |
| and not full | 7-7.5 | 2.5-4.5 | 2.5-4 | 2.5-4 | | 4.5-5 | 2.5-4 |
| ≤5 | | | | | | | |
| | Relatively | Little ≤2 | Tiny | Small ≤2 | | Relatively | Tiny |
| | intense | | 0.5-2 | | | poor | 0.5-2 |
| | 5.5-6.5 | | | | | 2.5-4 | |
| | Intense | | None 0 | | | Poor ≤2 | None 0 |
| | ≤5 | | | | | | |

Atomization cores and ceramic heating elements (Feelm heating element, Shenzhen McWell Technology Co., Ltd.) of the same shape and size produced in the Examples and the Comparative Examples of this application are selected for basic performance testing and smoking.

TABLE 2

| | | Pore size | | | Aroma |
|---|---|---|---|---|---|
| | | (diameter | E-liquid | | reduction |
| | Porosity | of pore throat) | guiding | Taste | degree |
| Number | (%) | (μm) | time (s) | score | score |
| Ceramic | 55 | 18 | 27 | 6 | 6 |
| heating | | | | | |
| element | | | | | |
| Comparative | 5 | 6 | / | / | / |
| Example 1 | | | | | |
| Comparative | 45.5 | 14.3 | 35 | 5 | 5 |
| Example 2 | | | | | |
| Example 1 | 62 | 25 | 12 | 7.5 | 8 |
| Example 2 | 67 | 35 | 7 | 8 | 8 |
| Example 3 | 69 | 58 | 6 | 8 | 8 |
| Example 4 | 72 | 57 | 6 | 7 | 7 |
| Example 5 | 60 | 20 | 7 | 8 | 8 |
| Example 6 | 64 | 33 | 8 | 8 | 8 |
| Example 7 | 72.5 | 36 | 6 | 8.5 | 8.5 |
| Example 8 | 74.5 | 42 | 6 | 8.5 | 8.5 |
| Example 9 | 68.3 | 25 | 7 | 8 | 8 |
| Example 10 | 64.3 | 22.5 | 7 | 7.5 | 8 |

In Comparative Example 1, the porosity and pore size are relatively low, during the e-liquid guiding test, the solvent cannot reach the surface of the sample, the e-liquid guiding time cannot be calculated, and the taste and aroma reduction degree cannot be scored.

From the results in the above table, it can be seen that compared with the ceramic heating element, the e-liquid guiding effect of the porous glass atomization core has been greatly improved, and the taste and aroma reduction degree have also been improved to a certain extent.

By comparing the micro-morphologies of FIG. 1 to FIG. 7, in Comparative Example 1, the porous glass is produced by using only the glass, the pore-forming agent and the additive phase. The porous glass has fewer surface pores. The majority of the internal structure is closed-pore. By adding the fiber component as the framework, the pores in the surface and interior are significantly increased, and most of them are open pores. At the same time, it can be seen from the porosity and pore size test data that the porosity of Comparative Example 1 is only 5%, while in the Examples provided by this application, the porosity and pore size of the sample are greatly improved by adding the fiber component as the framework.

In Example 6, some zeolite powder is added as the additive phase. Compared with Example 2, the porosity and pore size of the sample is slightly reduced due to the reduction in the amount of fiber that produces the bridging effect, and the granular zeolite powder can be clearly seen in the cross section. After the zeolite powder is added, the overall taste is not greatly affected, but the strength of the heating element can be improved to a certain extent, and the deformation of the heating element can be alleviated.

In Examples 7-10, no additive phase is added, only the glass powder and fibers are used as the framework. During the production process, the amount of the pore-forming agent added is increased. The pore-forming agent can fully disperse the fibers from each other, so that the effective fibers can easily form a connect structure. When the effective fiber content is sufficient, such as in Examples 7-8, a porous channel structure with high porosity and high communication is formed as a whole. However, when the pore-forming agent content is too high and the fiber (effective fiber) content is relatively low, the product shrinks greatly during the production process, and the porous glass substrate with high porosity cannot be formed. Compared with the examples with additive phases, the porous glass substrate without additive phases has smoother porous channels and surface, and the heating element produced therefrom has a purer smoking taste.

Compared with the existing ceramic heating element, the atomization core produced in the Examples of this application has significantly improved e-liquid guiding rate. At the same time, since the glass is smooth and continuous, the split-phase transmission is reduced, and the aroma reduction degree and the overall taste score are also greatly improved.

A loading test of the porous glass atomization cores produced in Examples 7-10 shows that the attenuation of smoke volume of the porous glass atomization cores during smoking is small, and under the condition of 1000 puffs, the porous glass atomization cores produced in Examples 7-10 have basically no attenuation. The attenuation of smoke volume of Example 7 is shown in FIG. 14. Compared with the commercially available ceramic heating element (Shenzhen Maxwell Technology Co., Ltd., Feelm heating clement), the porous glass atomization core of Example 7 is less likely to suffer from carbon deposition after smoking. As shown in FIG. 15, after 400 puffs, the porous glass atomization core (left panel) has significant advantages over the ceramic heating element (right panel) in terms of carbon deposition. After 400 puffs, the test for the commercially available ceramic heating element cannot continue due to severe carbon deposition. Examples 8-10 are close to the effect of Example 7 in terms of carbon deposition, and also have significant advantages over ceramic heating elements, which are not shown one by one.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A production method for a porous glass atomization core, comprising:
S1: producing porous glass by:
scheme one: a production method for the porous glass comprising: mixing glass powder, a fiber component, a pore-forming agent, and an additive phase to produce a green body, and performing debinding and sintering to obtain the porous glass; or
scheme two: a production method for the porous glass comprising: mixing glass powder, a fiber component, and a pore-forming agent to produce a green body, and performing debinding and sintering to obtain the porous glass; and
S2: using the porous glass as a substrate, and arranging a heating unit on the substrate.

2. The production method of claim 1, wherein the fiber component has a diameter of 3-30 μm and a length of 20-500 μm.

3. The production method of claim 2, wherein an aspect ratio of the fiber component is 1-10, and/or,
wherein a proportion of fibers with a length of 50 μm or more in the fiber component is 25% or more.

4. The production method of claim 1, wherein, in scheme one, raw materials comprise 15-50% of fiber component by a total mass of the raw materials, or
wherein, in scheme two, by a total mass of the glass powder and the fiber component, a proportion of the glass powder is 40-62%, and a proportion of the fiber component is 38-60%, and/or, an amount of the pore-forming agent used is 0.3-2.5 times a total mass of the glass powder and the fiber component.

5. The production method of claim 1, wherein in scheme one and scheme two, at least one of a casting process, an injection molding process, a dry pressing process, and a gel casting process is independently selected to produce the green body, and/or,
wherein a debinding temperature is 200-800° C., and a debinding time is 5-50 h, and/or,
wherein a sintering temperature is 900-1250° C. or 1180-1320° C., and a sintering time is 10-180 min.

6. The production method of claim 1, wherein the production meets at least one of the following:
(1) a softening temperature of the glass powder is 600-1200° C.,
(2) a particle size of the glass powder is 10 μm or less,
(3) the fiber component comprises at least one of silicon carbide fiber, silicon nitride fiber, aluminum silicate fiber, quartz fiber, mullite fiber, alumina fiber, hydroxyapatite fiber, and zirconium oxide fiber,
(4) the pore-forming agent comprises at least one of carbon powder, polystyrene, polymethyl methacrylate, polylactic acid, polyvinyl alcohol, polyethylene terephthalate, engineering plastics, starch, cellulose, sawdust, and graphite powder,
(5) a particle size of the pore-forming agent is 10-300 μm.

7. The production method of claim 1, wherein the heating unit in step S2 comprises a heating wire, a heating net or a heating film.

8. A porous glass atomization core, comprising:
a substrate comprising porous glass; and
a heating unit arranged on the substrate,
wherein, in scheme a, a porosity of the porous glass is 50-70%, and an average pore size is 10-200 μm, or
wherein, in scheme b, a porosity of the porous glass is 65-80%, and an average pore size is 10-200 μm.

9. The porous glass atomization core of claim 8, wherein the porous glass in scheme a is produced by a production method comprising:
S1: producing porous glass by mixing glass powder, a fiber component, a pore-forming agent, and an additive phase to produce a green body, and performing debinding and sintering to obtain the porous glass; and
S2: using the porous glass as a substrate, and arranging a heating unit on the substrate, or
wherein the porous glass in scheme b is produced by a production method comprising:
S1: mixing glass powder, a fiber component, and a pore-forming agent to produce a green body, and performing debinding and sintering to obtain the porous glass; and
S2: using the porous glass as a substrate, and arranging a heating unit on the substrate.

10. The porous glass atomization core of claim 8, wherein the porous glass in the scheme b comprises a framework and multi-directional communication pores, the framework comprising a fiber body and a glass body surrounding the fiber body, and an average pore size of the multi-directional communication pores is 10-200 μm.

11. The porous glass atomization core of claim 10, wherein the fiber body has a diameter of 3-30 μm and a length of 20-500 μm.

12. The porous glass atomization core of claim 11, wherein an aspect ratio of the fiber body is 1-10, and/or
a proportion of fibers with a length of 50 μm or more in the fiber body is 25% or more.

13. An electronic atomizer, comprising:
the porous glass atomization core of claim 8.

14. The production method of claim 2, wherein the diameter is 10-25 μm and the length is 20-150 μm.

15. The production method of claim 3, wherein the aspect ratio of fibers with the length of 50-150 μm in the fiber component is 2-5, and/or,
wherein the proportion of fibers with the length of 50 μm or more in the fiber component is 40% or more.

16. The production method of claim 4, wherein, in scheme one, by the total mass of the raw materials, the raw materials comprise the following mass percent of components:
20-70% of glass powder,
15-50% of fiber component,
10-70% of pore-forming agent,
0-50% of additive phase.

17. The production method of claim 16, wherein, in scheme one, the mass percent of the additive phase is 1-50%.

18. The production method of claim 5, wherein the debinding temperature is 200-350° C.

19. The production method of claim 6, wherein, in (2), the particle size is 3000 meshes or less, and/or
wherein, in (5), an average particle size of the pore-forming agent is 70-90 μm.

20. The production method of claim 7, wherein the heating wire or heating net is to be embedded in the green body forming process, and is then sintered together with a formed body to obtain a porous glass atomization core, and
wherein, for the heating film, a thick film resistive heating film is printed by screen printing, or a thin film resistive heating film is formed by spraying or magnetron sputtering, a pattern of the heating film is designed, and then the porous glass atomization core is obtained through a sintering step.
